(19) United States
(12) Patent Application Publication
(10) Pub. No.: US 2026/0296180 A1
(43) Pub. Date: Oct. 1, 2026

(54) TANK SUPPORT ASSEMBLY FOR HYDROGEN STORAGE SYSTEM AND FUEL CELL ELECTRIC VEHICLE INCLUDING SAME

(71) Applicant: American Honda Motor Co., Inc., Torrance, CA (US)

(72) Inventors: Randy CHEUNG, Ypsilanti, MI (US); John Mark JONES, White Lake, MI (US); Sandor SZENTES, Kecskemét (HU); Gyula TOTH, Northville, MI (US)

(21) Appl. No.: 19/094,860

(22) Filed: Mar. 29, 2025

(51) Int. Cl. B60K 15/067; B60L 50/70; F17C 13/08; H01M 8/04082; B60K 15/03

(52) U.S. Cl. CPC B60K 15/067; B60L 50/70; F17C 13/084; H01M 8/04201; B60K 2015/03171; B60K 2015/03315; B60K 2015/03486; F17C 2205/0103; F17C 2221/012; F17C 2270/0171; F17C 2270/0184; H01M 2250/20

(57) ABSTRACT

A tank support assembly for a fuel cell electric vehicle can include a support stand configured to receive and support at least one hydrogen gas storage tank, a base configured to receive and support the tank, and bearing plate movably connected to the support stand at a location that is spaced away from the base. The bearing plate can be configured to be connected to the tank. A strap assembly can be configured to constrain the tank onto the support stand. The strap assembly can include a flexible strap and a tension spring. The tension spring can be configured to apply a radial direction holding force to compensate for radial expansion of the tank. The plate spring can be configured to maintain contact between the bearing plate and the tank as the tank expands and contracts along a longitudinal axis of the tank.

### BACKGROUND

The disclosed subject matter relates to a fuel cell electric vehicle. More particularly, the disclosed subject matter relates to methods and apparatus for supporting at least one tank filled with hydrogen gas to be used in a fuel cell system of the electric vehicle.

An electric vehicle can include a battery assembly that is connected to one or more electric motors that drive one or more wheels of the vehicle. The battery assembly can be recharged by an internal combustion engine that is mounted on the vehicle (also known as a hybrid electric vehicle) and/or by connecting the battery to an external source of electric power. In these configurations, the electric vehicle ultimately relies on fossil fuels to generate electric power. The electric vehicle that relies on fossil fuels might not be considered carbon-neutral even though the electric vehicle itself might not emit carbon monoxide during its use.

As an alternative to a hybrid electric vehicle or a battery electric vehicle, an electric vehicle can include a fuel cell system that generates electric power for charging the battery assembly. The fuel cell system can include a plurality of fuel cells (also referred to as a fuel cell stack) stacked in series to provide a desired voltage and/or stacked in parallel to provide desired current. Each fuel cell can include an anode, a cathode and an electrolyte sandwiched between the anode and the cathode. There are many different types of electrolytes that can be used with the fuel cell. A proton exchange member (“PEM”) fuel cell is a fuel cell that includes a polymer electrolyte membrane, uses gaseous hydrogen as a fuel, and combines the hydrogen with oxygen from the ambient environment to produce electrons, water and heat. Thus, a fuel cell system can be carbon neutral.

### SUMMARY

Some embodiments are directed to a tank support assembly for a hydrogen storage system of a fuel cell electric vehicle. The tank support assembly can include a support stand, a base, a bearing plate, a strap assembly and a plate spring. The support stand can be configured to receive and support at least one hydrogen gas storage tank. The base can be connected to the support stand and configured to receive and support the hydrogen gas storage tank. The bearing plate can be movably connected to the support stand at a location that is spaced away from the base. The bearing plate can oppose the base and be configured to be connected to the hydrogen gas storage tank. The strap assembly can be connected to the support stand at a location that is between the base and the bearing plate and configured to constrain the hydrogen gas storage tank onto the support stand. The strap assembly can include a flexible strap, a tension spring and a stress relief spring. The tension spring can be connected between the support stand and the flexible strap. The tension spring can be configured to apply a radial direction holding force to compensate for radial expansion of the hydrogen gas storage tank, and the tension spring can have a spring constant. The stress relief spring can be connected between the support stand and the flexible strap, and the stress relief spring can have a spring constant that is greater than the spring constant of the tension spring. The plate spring can be connected to the bearing plate and configured to maintain contact between the bearing plate and the hydrogen gas storage tank as the hydrogen gas tank expands and contracts along a longitudinal axis of the hydrogen gas storage tank.

Some embodiments are directed to a tank support assembly for a hydrogen storage system of a fuel cell electric vehicle. The tank support assembly can include a support stand, a base, a bearing plate, a flexible strap, a first spring assembly and a second spring assembly. The support stand can be configured to receive and support at least one hydrogen gas storage tank. The base can be connected to the support stand and configured to receive and support the hydrogen gas storage tank. The bearing plate can be connected to the support stand and opposing the base, and configured to be connected to the hydrogen gas storage tank. The flexible strap can have a first end and a second end, and be configured to constrain the hydrogen gas storage tanks against the support stand. The first spring assembly can be connected between the support stand and the first end of the flexible strap, and be configured to bias the flexible strap against the hydrogen gas storage tank, the first spring assembly has a spring constant. The second spring assembly can be connected to the bearing plate, and configured to bias the bearing plate against the hydrogen gas storage tank and permit displacement of the bearing plate as the hydrogen gas storage tank undergoes axial expansion and contraction.

Some embodiments are directed to a tank support assembly for a hydrogen storage system of a fuel cell electric vehicle. The tank support assembly can include a support stand, a base, a bearing plate, a flexible strap, a first spring assembly, a second spring assembly, and third spring assembly. The support stand can be configured to receive and support a plurality of hydrogen gas storage tanks. The base can be connected to the support stand and configured to receive and support the hydrogen gas storage tanks. The bearing plate can be connected to the support stand and opposing the base, and configured to be connected to the hydrogen gas storage tanks. The flexible strap can have a first end and a second end. The first strap can be configured to constrain one of the hydrogen gas storage tanks against the support stand. The first spring assembly can be connected between the support stand and the first end of the flexible strap, and configured to bias the flexible strap against the one of the hydrogen gas storage tanks. The first spring can have a spring constant. The second spring assembly can be connected between the support stand and the second end of the flexible strap. The second spring assembly can have a spring constant that is greater than the spring constant of the first spring assembly. The third spring assembly can be connected to the bearing plate and configured to bias the bearing plate against the one of the hydrogen gas storage tanks and permit displacement of the bearing plate as the one of the hydrogen gas tank undergoes axial expansion and contraction.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a side view of an electric vehicle that includes a tank support assembly made in accordance with principles of the disclosed subject matter.

FIG. 2 is a perspective view of a hydrogen storage system of the electric vehicle of FIG. 1.

FIG. 3 is a perspective view of the tank support assembly of the electric vehicle of FIG. 1 with a plurality of hydrogen gas storage tanks mounted thereon.

FIG. 4 is a top perspective view of the tank support assembly of FIG. 3.

FIG. 5 is a perspective view of the tank support assembly of FIG. 3 with two of the hydrogen gas storage tanks removed from the tank support assembly of FIG. 3.

FIG. 6 is a perspective view of the tank support assembly of FIG. 3 with all of the hydrogen storage tanks removed.

FIG. 7 is a perspective view of a first spring assembly of the tank support assembly of FIG. 3.

FIG. 8 is a side view of a second spring assembly of the tank support assembly of FIG. 3.

FIG. 9 is an enlarged view of an upper portion of FIG. 6.

FIG. 10 is an enlarged view of a lower portion of FIG. 6.

FIG. 11 is a plan view of a support plate of the tank support assembly of FIG. 3.

FIG. 12 is a partial side view of the tank support assembly of FIG. 3 and looking in the direction of arrow A11 of FIG. 4.

FIG. 13 is a perspective view of an alternate embodiment of the tank support assembly for the electric vehicle of FIG. 1.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

An electric vehicle can be a passenger vehicle, a bus, a commercial transport vehicle, a construction vehicle, a boat, a spacecraft, or an aircraft. A commercial transport vehicle can be a van, a truck, or a tractor-trailer (also referred to as a semi-trailer truck, a trailer truck, or a semi) that is configured to transport products from location to location. Tractor-trailers can be advantageous for carrying large quantities of products or heavy products over short distances and long distances. A conventional tractor-trailer can include a compression-ignition internal combustion engine. Not only does the engine emit carbon compounds and undesirable compounds of nitrogen, but also particulates such as soot. Thus, it can be advantageous to provide a tractor-trailer with at least one electric motor and a battery pack that powers the electric motor(s).

In order to provide an advantageous range for an electric vehicle, the battery should have a large energy storage capacity. However, current-technology batteries are relatively heavy and the increased mass of the battery pack could adversely impact the travel range between charging events. A fuel cell system could overcome this potential disadvantage by charging the battery pack while the electric vehicle is traveling, thus extending the driving range of the electric vehicle.

In order to charge the battery pack via fuel cell technology while traveling, the electric vehicle can carry an on-board supply of hydrogen gas. However, the tank(s) for storing a volume of hydrogen gas that provides an advantageous range for the electric vehicle can be relatively large. It could be desirable to limit the overall length and width of the electric vehicle. Thus, it can be advantageous to creatively package a hydrogen storage system with a minimum footprint on the electric vehicle.

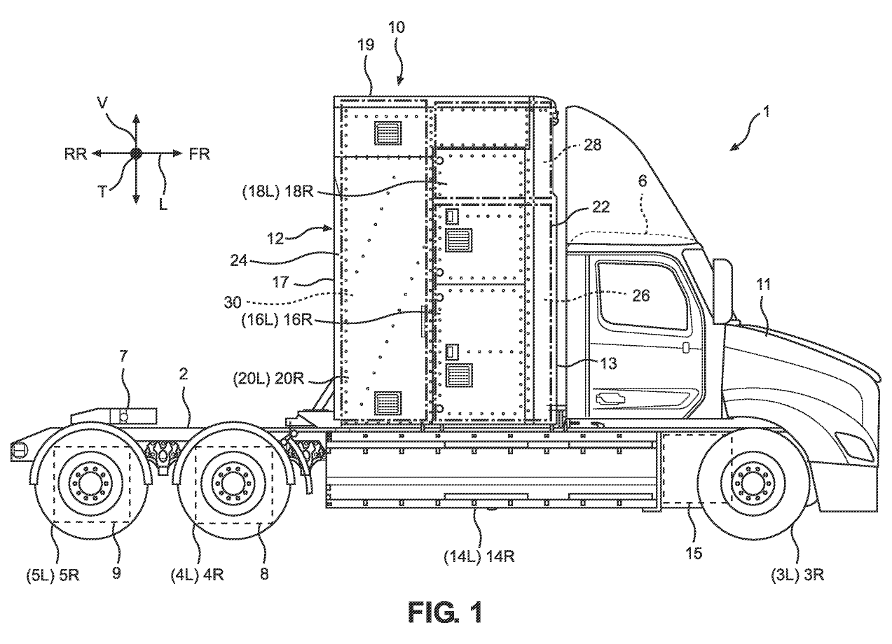

FIG. 1 illustrates an embodiment of an electric vehicle 1 (hereinafter “vehicle”) made in accordance with principles of the disclosed subject matter. The vehicle 1 can extend in a longitudinal direction L, a transverse direction T and a vertical direction V. The longitudinal direction L includes a front direction FR and a rear direction RR and the transverse direction includes a left direction LT and a right direction RT. The vehicle 1 shown in FIG. 1 can be specialized for use as a commercial transport vehicle.

The vehicle 1 can include a main power system 10, a chassis 2, a pair of front wheels 3L, 3R and a front pair of dual rear wheels 4L, 4R, a rear pair of dual rear wheels 5L, 5R, a cab 6, a fifth wheel 7, and a hood 11. The left-side wheels 3L, 4L, 5L are obstructed from view and can be the same as the right-side wheels 3R, 4R, 5R. The wheels 3L, 3R, 4L, 4R, 5L, 5R can be connected to and suspended from the chassis 2 in any appropriate manner. The chassis 2 can include a pair of frame rails that extend in the longitudinal direction L from a location in front of the front wheels 3L, 3R to a location behind the rearward dual wheels 5L, 5R. The frame rails can be spaced apart from each other in the transverse direction T. The cab 6 and the fifth wheel 7 can be mounted on the chassis 2 by any appropriate manner. The main power system 10 can be mounted on the chassis 2 at a location that is adjacent to the cab 6 and in front of the front pair of dual rear wheels 4L, 4R in the longitudinal direction L. The main power system 10 can be connected to the chassis 2 by any appropriate manner.

The vehicle 1 can include a first electric motor 8 that drives the front pair of dual rear wheels 4L, 4R and a second electric motor 9 that drives the rear pair of dual rear wheels 5L, 5R. The electric motors 8, 9 are schematically illustrated in phantom. The main power system 10 can generate, store, and distribute electric power to the electric motors 8, 9 and supply electric power generated by either of the electric motors 8, 9 to a battery pack 15 of the main power system 10..

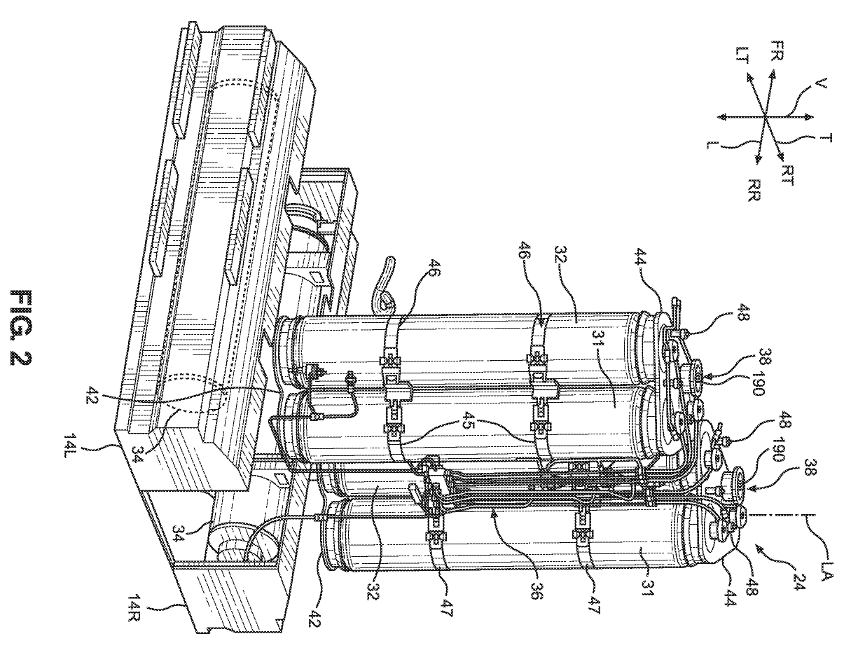

The main power system 10 can include a main housing 12 and a pair of saddle enclosures 14L, 14R. The left-side saddle enclosure 14L is shown in FIG. 2 and obstructed from view in FIG. 1. The main housing 12 can be mounted on the chassis 2 at a location that is behind the cab 6 in the longitudinal direction L and in front of the front pair of rear dual wheels 4L, 4R in the longitudinal direction L. The main housing 12 can extend along the top of the chassis 2 in the longitudinal direction L and the transverse direction T. The main housing 12 can extend away from the chassis in the vertical direction V.

The main power system 10 can be include a fuel cell system 22 (also referred to as an FCS or as an FCS system) that generates electricity for powering the vehicle 1 and a hydrogen storage system 24 (also referred to as a HSS or as a HSS system) for storing a suppl of hydrogen gas for the fuel cell system 22. The FCS 22 and the HSS 24 are schematically illustrated in phantom. FIG. 2 shows the HSS 24 in its orientation in the vehicle 1.

The main power system 10 can include a battery pack 15 that includes a plurality of battery cells. Each of the battery cells can store and discharge electricity. The battery pack can be mounted between the frame rails of the chassis 2. The battery pack 15 can be in electrical communication with the FCS 22 and the electric motors 8, 9. The battery pack 15 is obscured from view in FIG. 1 and shown in phantom.

The main housing 12 can contain the FCS 22 and the HSS 24 and shelter these systems 22, 24 from the ambient environment. The main housing 12 can include a plurality of access panels 13, 16L, 16R, 17, 18L, 18R, 19, 20L, 20R. The left-side panels 16L, 18L, 20L are obstructed from view and can be a mirror copy of the right-side panels 16R, 18R, 20R. The access panels 16L, 16R, 17, 18L, 18R, 20L, 20R can be removably or pivotally mounted to provide convenient access to the components and systems of the main power system 10. The front access panel 13 can cover a front side of the main housing 12 that faces the rear side of the cab 6. The lower access panels 16L,16R can selectively open and close a fuel cell compartment 26 illustrated in phantom. The upper access panels 18L, 18R can selectively open and close a heat exchanger compartment 28 and an upper portion of the fuel cell compartment 26. The compartments 26, 28 are schematically illustrated in phantom. The rear panel 17 and the fuel access panels 20L, 20R can selectively open and close a hydrogen compartment 30 that is schematically illustrated in phantom. The rear panel 17 can extend along the entirety of the rear side of the main housing 12. The top panel 19 can cover at least a portion of the top side of the main housing 12 and can include an exhaust outlet for heat exchangers housed in the heat exchanger compartment 28.

The saddle enclosures 14L, 14R can be connected to and extend along a respective one of the frame rails of the chassis 2 in the longitudinal direction L and away from the respective frame rail in the vertical direction V. The saddle enclosures 14L, 14R can protect respective portions of the main power system 10 from objects, dirt, debris and fluids. The saddle enclosures 14L, 14R can be located between the left front wheel 3L, 3R and the forward dual wheels 4L, 4R. The saddle enclosures 14L, 14R can extend away from the respective frame rail in the transverse direction T. The saddle enclosures 14L, 14R can be connected to the chassis 2 by any appropriate manner such as, but not limited to, threaded fasteners, clamps, straps, clips, hinges, or any combination of these attachment devices.

The FCS 22 can be housed within the fuel cell compartment 26 and include at least one fuel cell stack and the components and systems that supply hydrogen and oxygen to the fuel cell stack, control the electrical power output, collect and remove the water produced by the fuel cell stack, circulate cooling water for the fuel cell stack, and humidify the ambient air prior to supplying the ambient air to the fuel cell stack.

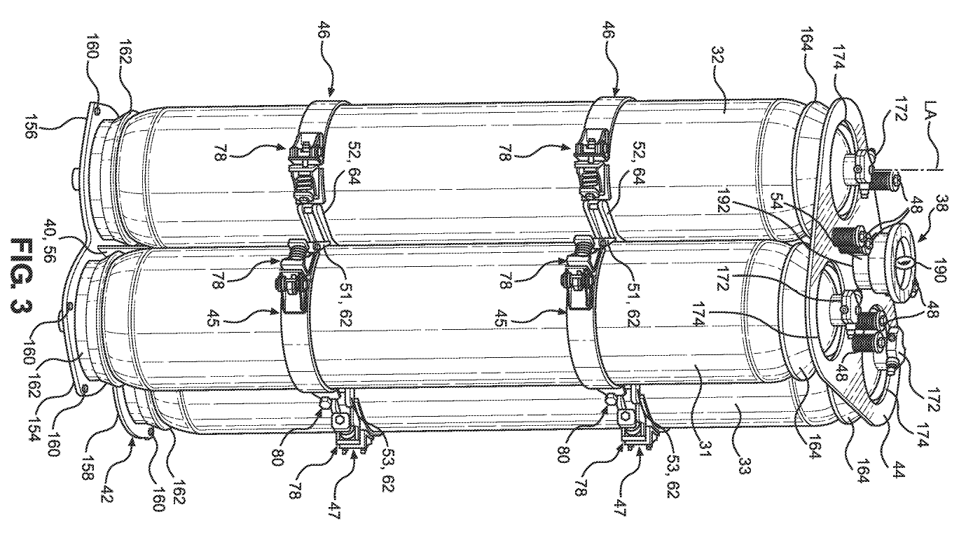

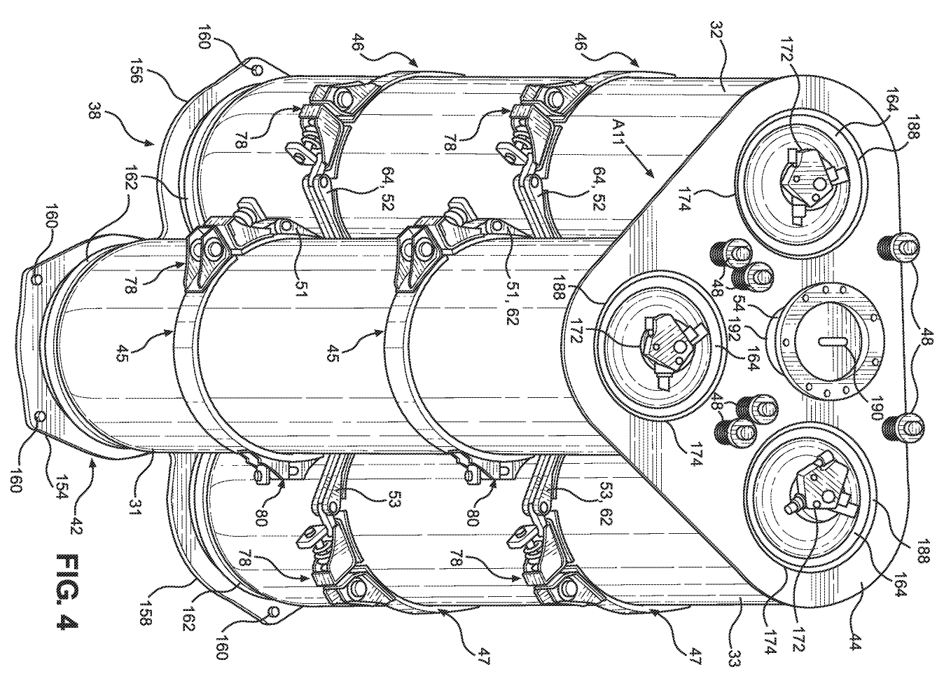

The HSS 24 can be in fluid communication with FCS 22 and housed within the saddle enclosures 14L, 14R and the hydrogen compartment 30. Referring to FIG. 2, the HSS 24 can include a plurality of vertical tanks 31, 32, 33 mounted inside the hydrogen compartment 30 of the main housing 12 and a pair of horizontal tanks 34 mounted on the frame rails of the chassis 2. The third vertical tanks 33 are obstructed from view in FIG. 2 and the left-side horizontal tank 34 is shown in phantom in FIG. 2. FIGS. 3 and 4 show the third vertical tank 33. Each of the tanks 31, 32, 33, 34 can be referred to as a hydrogen gas storage tank.

The vertical tanks 31, 32, 33 can be mounted inside of the hydrogen compartment 30 in the spatial relationship illustrated in FIG. 2. Although FIG. 2 shows six vertical tanks 31, 32, 33, any appropriate number of vertical tanks 31, 32, 33 can be mounted inside of the hydrogen compartment 30 in order to achieve the desired hydrogen capacity and performance of the vehicle 1. The vertical tanks 31, 32, 33 can be oriented with their longitudinal axis LA extending parallel to, or substantially parallel to, the vertical direction V of the vehicle 1. Further, the vertical tanks 31, 32, 33 can be arranged in triangular arrays. This orientation can provide a minimum footprint within the main housing 12 for a predetermined target hydrogen gas storage capacity. This minimum footprint can contribute to a packaging layout of the FCS 22, the HSS 24, and a thermal management system for cooling the FCS 22. This minimum footprint can promote ease of assembly onto the vehicle 1, ease of access for routine maintenance, and/or ease of removing/reinstalling/replacing component(s) and system(s) of the FCS 22.

The horizontal tanks 34 can be located between the chassis 2 and a respective one of the saddle enclosures 14L, 14R in the transverse direction T. The saddle enclosures 14L, 14R can shield the horizontal tanks 34 against objects, fluid, dirt and debris.

The main power system 10 can include a centralized hydrogen distribution system 36 that can connect the HSS 24 to one or more fuel cells of the FCS 22 and supply hydrogen gas from each of the tanks 31, 32, 33, 34 to all of the fuel cell(s). The centralized hydrogen distribution system 36 can connect the HSS 24 to an external source of hydrogen gas for refilling the tanks 31, 32, 33, 34. The centralized hydrogen gas distribution system 36 can include any appropriate number of valves, conduits, pressure regulators, and/or manifolds to supply hydrogen gas to and distribute hydrogen gas from the tanks 31, 32, 33, 34 in order to achieve a desired refilling performance for the tanks 31, 32, 33, 34 and operational performance for the fuel cell(s).

Each of the vertical tanks 31, 32, 33 can independently expand and contract due to changing pressure of the hydrogen gas contained in each of the vertical tanks 31, 32, 33. Referring to FIG. 5, each of the vertical tanks 31, 32, 33 can expand and contract in a radial direction R of the vertical tanks 31, 32, 33 and an axial direction A of the vertical tanks 31, 32, 33 while supplying hydrogen gas to the fuel cells. The axial direction A can be parallel to a longitudinal axis LA of a respective tank. The vertical tanks 31, 32, 33 can be oriented in the hydrogen compartment 30 with their longitudinal direction LA parallel to or substantially parallel to the vertical direction V of the vehicle 1. In this orientation, the vertical tanks 31, 32, 33 can have a radial direction R that lies in a plane that extends in the longitudinal direction L and the transverse direction T of the vehicle 1.

Referring to FIGS. 2-6, the HSS 24 can include two tank support assemblies 38 that can be the same as or similar to each other. Each of the tank support assemblies 38 can constrain a respective set of the vertical tanks 31, 32, 33 in their predetermined location within the hydrogen compartment 30 while also allowing for expansion and contraction of each of the vertical tanks 31, 32, 33 in the axial direction A and the radial direction R. Axial expansion and contraction of vertical tanks 31, 32, 33 can also be referred to as longitudinal expansion and contraction of the vertical tanks 31, 32, 33.

Each component of the tank support assembly 38 described below can be fabricated from any appropriate material such as, but not limited to, steel, aluminum, aluminum alloy, titanium, titanium alloy, carbon fiber, fiber reinforced plastic, plastic. Each component of the tank support assembly 38 can be fabricated from the same material. In alternate embodiments, any one or more of the components of the tank support assembly 38 can be fabricated from a material that is different from any one or more other components of the tank support assembly 38.

Referring to FIGS. 2-6, the tank support assembly 38 can include a support stand 40, a base 42, a bearing plate 44, a plurality of strap assemblies 45, 46, 47 and at least one plate spring assembly 48. The support stand 40 is obstructed from view in FIG. 2.

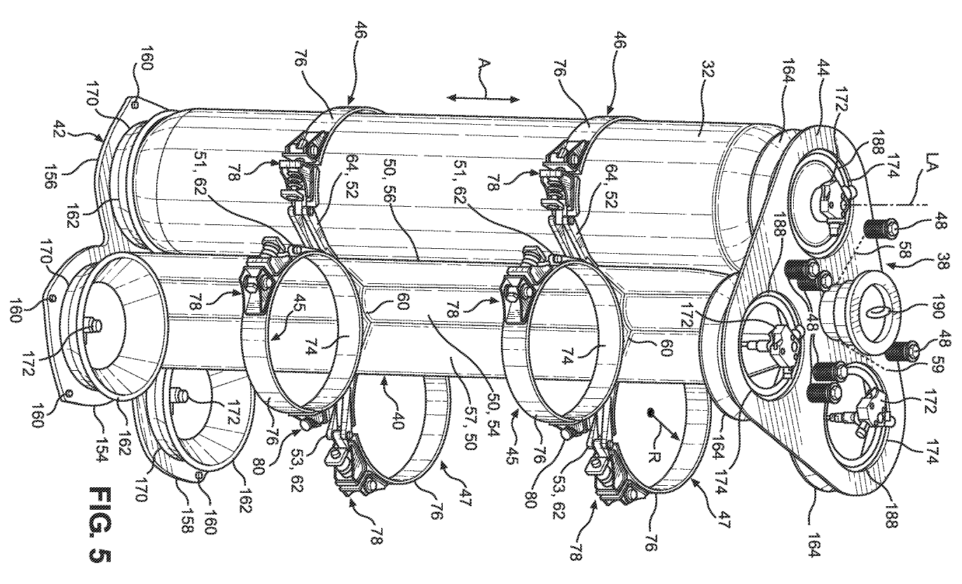

Referring to FIGS. 5 and 6, the support stand 40 can include a main body 50 and a plurality of brackets 51, 52, 53. A lower portion of the main body 50 is visible in FIG. 3, with the remainder of the main body 50 obstructed from view by the vertical tanks 31, 32, 33. Portions of the pair of second brackets 52 are obstructed from view in FIG. 4 by the second vertical tank 32 and a first plate 56. Portions of the pair of third brackets 53 are obstructed from view in FIG. 5 by the main body 50.

Referring to FIGS. 5 and 6 collectively, the support stand 40 can include a cylindrical shaft 54 and a plurality of plates 56, 57, 58, 59 spaced about the circumference of the shaft 54. The plurality of plates can include a first plate 56, a second plate 57, a third plate 58 and a fourth plate 59. The third plate 58 and the fourth plate are obstructed from view in FIGS. 5 and 6 and shown schematically and in phantom in FIG. 5. The first vertical tank 31 can be located between the first plate 56 and the second plate 57, the second vertical tank 32 can be located between the first plate 56 and the third plate 58, and the third vertical tank 33 can be located between the second plate 57 and the fourth plate 59. An empty space can extend between the third plate 58 and the fourth plate 59. The empty space is obstructed from view in FIGS. 5 and 6. The plates 56, 57, 58, 59 can be connected to the shaft 54 by any appropriate manner such as, but not limited to, welding, threaded fasteners, rivets, adhesives, clamps, clips, or any combination of these structures.

Each of the plurality of brackets 51, 52, 53 can be mounted onto the cylindrical shaft 54 and a respective pair of the plates 56, 57, 58, 59. Referring to FIG. 5, each of the brackets 51, 52, 53 can include a central body 60 and a pair of arms 62, 64. The second arm 64 of each of the first brackets 51 is obstructed from view in FIG. 5 by the first strap assembly 45. The central body 60 and the first arm 62 of each of the second brackets 52 is obstructed from view in FIG. 5 by the second vertical tank 32. The second arm 64 of each of the third bracket 53 is obstructed from view in FIG. 5 by the second plate 58.

The central body 60 of each of the first brackets 51 can abut the shaft 54, the first plate 56 and the second plate 57 and extend along each of the plates 56, 57. The central body 60 of each of the second brackets 52 can be arranged in the same or similar manner with respect to the shaft 50, the first plate 56 and the third plate 58. The central body 60 of each of the third brackets 53 can be arranged in the same or similar manner with respect to the shaft 54, the second plate 57 and the fourth plate 59. The central body 60 of each of the brackets 51, 52, 53 can include a curved surface that faces a respective of one of the vertical tanks 31, 32, 33. The curved surface can be complimentary to the outer surface of the vertical tanks 31, 32, 33.

The arms 62, 64 can be connected to and extend away from the central body 60. The central body 60 can be located between the arms 62, 64. Each of the arms 62, 64 can terminate at a free end. The first arm 62 of each of the first brackets 51 can extend away from the first plate 56 and the second arm 64 of each of the first brackets 51 can extend away from the second plate 57. The first arm 62 of each of the second brackets 52 can extend away from the third plate 58 and the second arm 64 of each of the second brackets 52 can extend away from the first plate 56. The first arm 62 of each of the third brackets 53 can extend away from the second plate 57 and the second arm 64 of each of the third brackets 53 can extend away from the fourth plate 59.

The arms 62, 64 can be formed separately from the central body 60 and connected to the central body in any appropriate manner such as, but not limited to, welding, threaded fasteners, rivets, adhesives, clamps, clips, or any combination of these structures. However, alternate embodiments can include brackets 51, 52, 53 in which the arms 62, 64 are integrally formed as a single piece with the central body 60.

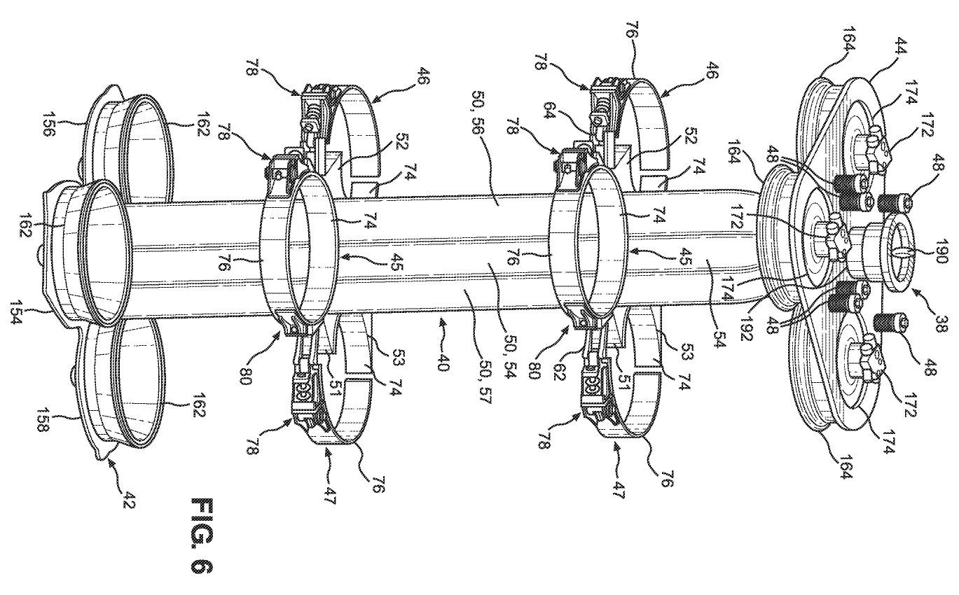

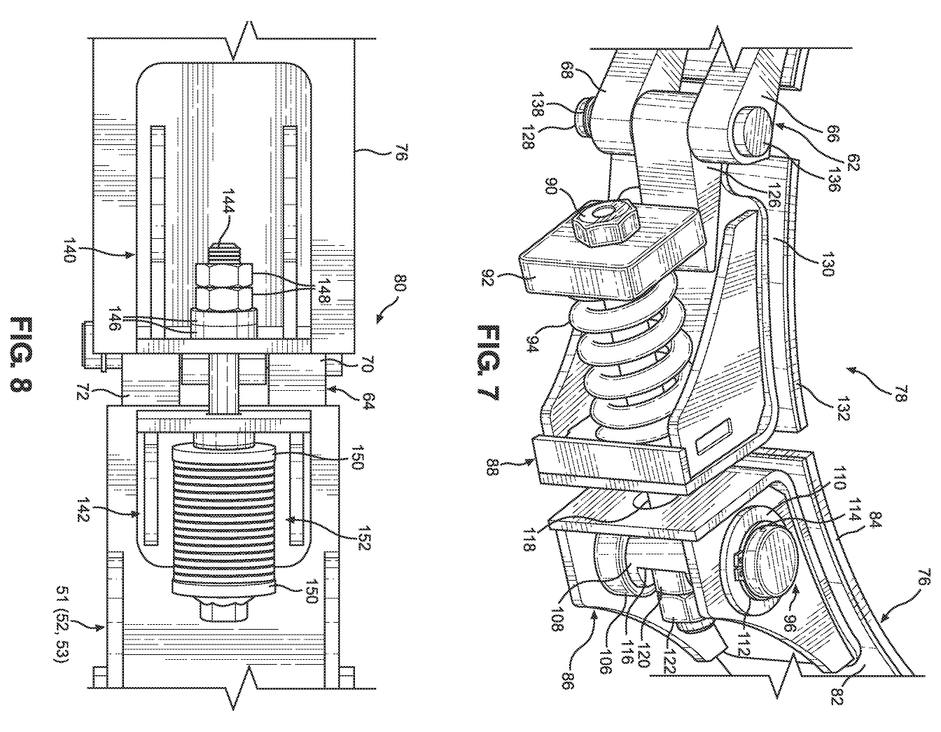

Referring to FIG. 7, each of the first arms 62 can include an upper arm portion 66 and a lower arm portion 68 that is spaced away from the upper arm portion 66 in the axial direction A of the respective one of the vertical tanks 31, 32, 33. Referring to FIG. 8, each of the second arms 64 can include an upper arm portion 70 and a lower arm portion 72. The upper arm portions 66, 70 can be formed separately from the lower arm portions 68, 72, respectively. However, alternate embodiments can include arms 62, 64 in which the upper arm portions 66, 70 are integrally formed with the lower arm portions 68, 72, respectively, by a connecting portion extending from each of the upper arm portions 66, 70 and the lower arm portions 68, 72, respectively.

Returning to FIGS. 5 and 6, the support stand 40 can include a plurality of cushion linings 74, a respective one of the cushion linings 74 can be mounted on a respective one of the central bodies 60. The cushion lining 74 can be elastically deformable and have a relative hardness that is less than the hardness of the vertical tanks 31, 32, 33 and a relative hardness that is less than the hardness of the flexible straps and/or main body 50. The cushion lining 74 can have a coefficient of friction that provides a desired frictional force between the cushion lining 74 and the respective one of the vertical tanks 31, 32, 33. The cushion lining 74 can be fabricated from any appropriate material such as, but not limited to, a natural rubber, a synthetic rubber, or any other known or future developed elastomeric material, or other soft and high friction material whether natural or synthetic.

Referring to FIGS. 3-6, each of the strap assemblies 45, 46, 47 can include a flexible strap 76, a first spring assembly 78, and a second spring assembly 80. The second spring assembly 80 of each of the second strap assembly 46 and the third spring assembly 47 are obstructed from view in FIG. 3-6. FIGS. 7 shows an enlarged view of the first spring assembly 78 and FIG. 8 shows an enlarged view of the second spring assembly 80.

Returning to FIGS. 5 and 6, the first spring assembly 78 can connect a first end of the flexible strap 76 to one of the arms 62, 64 of a respective one of the brackets 51, 52, 53 and the second spring assembly 80 can connect a second end of the flexible strap 76 to a different one of the arms 62, 64 of the respective one of the brackets 51, 52, 53. For example, the first spring assembly 78 of the first strap assembly 45 can be connected to the first arm 62 of the first bracket 51 and the second spring assembly 80 can be connected to the second arm 64 of the first bracket 51. Further, the first spring assembly 78 of the third strap assembly 47 can be connected to the first arm 62 of the third bracket 53 and the second spring assembly 80 can be connected to the second arm 64 of the third bracket 51. In contrast, the first spring assembly 78 of the second strap assembly 46 can be connected to the second arm 64 of the second bracket 52 and the second spring assembly 80 can be connected to the first arm 62 of the second bracket 52. This arrangement can locate the first spring assemblies 78 adjacent to and facing the closest one of the fuel access panels 20L, 20R. Thus, adjustment and maintenance of all of the first spring assemblies 78 can be easily performed through the opening in the main housing 12 when the respective fuel access panel 20L, 20R is removed.

Returning to FIG. 7, the flexible strap 76 can include a base layer 82 and a cushion layer 84. The base layer 82 can be formed from any appropriate material such as, but not limited to, metal, plastic, fabrics, and woven nylon, that has a desired level of flexibility, strength and durability. The cushion layer 84 can abut the outer surface of a respective one of the vertical tanks 31, 32, 33. The cushion layer 84 can be elastically deformable and have relative hardness that is less than the hardness of the vertical tanks 31, 32, 33. The surface of the cushion layer 84 that contacts the respective one of the vertical tanks 31, 32, 33 can have a coefficient of friction that provides a desired frictional force between the cushion layer 84 and the respective one of the vertical tanks 31, 32, 33. The cushion layer 84 can be fabricated from any appropriate material such as, but not limited to, a natural rubber, a synthetic rubber, or any other known or future developed elastomeric material, or other soft and high friction material whether natural or synthetic. The cushion layer 84 can abut and be connected to the base layer 82 by any appropriate manner such as, but not limited to, threaded fasteners, rivets, clamps, clips, stitches, welds, adhesive or any combination of these structures.

The first spring assembly 78 can apply a tension force to the flexible strap 76 so that the cushion layer 84 is held tightly against the respective one of the vertical tanks 31, 32, 33 and applies a radially compressive force against the respective one of the vertical tanks 31, 32, 33. The radially compressive force can increase the frictional force between the flexible strap 76 and the respective one of the vertical tanks 31, 32, 33. The first spring assembly 78 and the second spring assembly 80 can cooperate to compensate for radial expansion and contraction of the respective one of the tanks 31, 32, 33. The first spring assembly 78 and/or the second spring assembly 80 can be adjusted to account for manufacturing tolerance(s) in the tank support assembly 38 and diametrical tolerance of the respective one of the vertical tanks 31, 32, 33.

The first spring assembly 78 can include a first strap bracket 86, a first arm bracket 88, a first bolt 90, a first spring plate 92, a first spring 94 and a spring mount 96. The first strap bracket 86 can be connected to the flexible strap 76 and the first arm bracket 88 can be connected to one of the arms 62, 64. The first bolt 90 can be referred to as a tension bolt and the first spring 94 can be referred to as a tension spring.

The first bolt 90 can connect the first strap bracket 86 to the first arm bracket 88 and the first spring 94 can be connected to and between each of the first arm bracket 88 and the first bolt 90. The first spring plate 92 can be connected to the first bolt 90 and the first spring 94 can abut the first arm bracket 88 and the first spring plate 92. That is, the first spring 94 can be connected between the first strap bracket 86 and the support stand 40. The first spring 94 can be a coil spring that includes a first end that abuts the first arm bracket 88 and a second end that abuts the first spring plate 92.

Tightening the first bolt 90 can increase the compression of the first spring 94, which can increase the tension applied to the flexible strap 76 and increase the radial compression force applied to the respective one of the vertical tanks 31, 32, 33. Thus, tightening the first bolt 90 can increase the frictional force between the flexible strap 76 and the respective one of the vertical tanks 31, 32, 33. Loosening the first bolt 90 can decrease the compression of the first spring 94, which can decrease the tension applied to the flexible strap 76 and decrease the radial compression force applied to the respective one of the vertical tanks 31, 32, 33. Thus, the first spring assembly 78 can be adjusted to provide a desired tension in the flexible strap 76, and can be adjusted to accommodate manufacturing tolerance(s) of the tank support assembly 38 as well as the diametrical tolerance of the vertical tanks 31, 32, 33.

A portion of the first strap bracket 86 can be curved to conform to the circumference of the respective one of the vertical tanks 31, 32, 33. The curved portion of the first strap bracket 86 can abut and be connected to the base layer 82 of the flexible strap 76 by any appropriate structure(s) such as but not limited to threaded fasteners, rivets, clamps, clips, welds, adhesive or any combination of these structures.

The first strap bracket 86 can include a pair of through holes and a pair of collars 106 that surrounds a respective one of the through holes. Both through holes and the collar on the upper side of the first arm bracket 86 are obstructed from view in FIG. 7. The collar on the upper side of the first strap bracket 86 can be the same as or similar to the collar 106 on the lower side of the first strap bracket 86. Each collar 106 can be connected to the first strap bracket 86 by any appropriate manner such as, but not limited to, welding, adhesive, or a press-fit.

The spring mount 96 can include a first pivot pin 108, a pair of washers 110 and a pair of C-clips 112. The second one of the washers 110 and the second one of the C-clips 112 are obstructed from view by the lower side of the first strap bracket 86. The first pivot pin 108 can be configured to allow the first bolt 90 to pivot relative to the first strap bracket 86. This freedom of movement can accommodate large circumferential displacement of the respective strap assembly 45, 46, 47 caused by radial expansion and contraction of the respective one of the vertical tanks 31, 32, 33. That is, the first pivot pin 108 can be configured to allow the first bolt 90 to pivot relative to the first strap bracket 86 if the respective one of the vertical tank 31, 32, 33 expands in a radial direction beyond a first predetermined threshold.

The first pivot pin 108 can be a solid cylindrical member that passes through the through holes in each of the first strap bracket 86 and the collars 106. The collars 106 can rotatably support the first pivot pin 108. The collars 106 can also be referred to as bearings.

The first pivot pin 108 can include a pair of grooves 114 and a cutout 116. The second groove 114 is obstructed from view in FIG. 9. A respective one of the washers 110 can be located between the first arm bracket 86 and a respective one of the grooves 114. A respective one of the C-clips 112 can be removably attached in a respective one of the grooves 114. The C-clips 112 can abut the washers 110 to prevent removal of the first pivot pin 108 from the first strap bracket 86.

The first pivot pin 108 can be fabricated from a metal or metal alloy cylindrical member that is machined to form the grooves 114 and the cutout 116. The cutout 116 can be formed at a central portion of the first pivot pin 108 by removing a portion of the material of the cylindrical member at the location of the cutout 116.

The first pivot pin 108 can include a through hole that is opened at the cutout 116. The through hole is obstructed from view in FIG. 7. The first strap main plate 98 can include a through hole 118 and the first bolt 90 can pass through the through hole 118 and the through hole of the first pivot pin 108. The through hole 118 can be elongated along the pivot arc of the first bolt 90 to allow the first bolt 90 to pivot. The length of the elongation of the through hole can be set to a predetermined pivot arc for the first bolt 90, or set at any other desired length.

The spring mount 96 can include a pair of nuts 120, 122 that are threaded onto the first bolt 90. The cutout 116 can include a flat surface that forms a seat for the first nut 120. The tension force applied by the first spring 94 onto the first bolt 90 can bias the first nut 120 against the seat of the cutout 116. The second nut 122 can be completely within the cutout 116, or partially within the cutout 116, or completely outside the cutout 116.

The first arm bracket 88 can include a through hole through which the first bolt 90 extends. The through hole is obstructed from view in FIG. 7 by the first spring 94.

The first arm bracket 88 can include an extension 126 connected to and extending away from a portion of the first arm bracket 88 on which the base layer 130 is fixed. The extension 126 can be connected to the portion of the first arm bracket 88 by any appropriate structure(s) such as but not limited to threaded fasteners, rivets, clamps, clips, welds, adhesive or any combination of these structures. The extension 126 can have a generally teardrop shape that has a relatively big end and a relatively small end.

The extension 126 can include a through hole at the big end of the extension 126 and each of the upper arm portion 66 and the lower arm portion 68 can include a through hole. The through holes in the arm portions 66, 68 and the extension 126 are obstructed from view in Fig, 7. The tank support assembly 38 can include a second pivot pin 128 that extends through the through holes in each of the extension 126 and the arm portions 66, 68. The second pivot pin 128 can freely rotate within the through holes and allow the first arm bracket 88 to pivot relative to the first arm 62.

The second pivot pin 128 can include a head 136 and a groove. A C-clip 138 can be removably attached in the groove. The C-clip 138 obstructs the groove from view in FIG. 7. The arm portions 66, 68 can be captured between the C-clip 138 and the head 136 such that the C-clip 138 and the head 136 maintain the connection between the second pivot pin 128 and the second arm 62.

A portion of the first arm bracket 88 can be curved to conform to the circumference of the respective one of the vertical tanks 31, 32, 33. The second spring assembly 80 can include a base layer 130 and a cushion layer 132. The base layer 130 can abut and be connected to the curved portion of the first arm bracket 88 by any appropriate structure(s) such as but not limited to threaded fasteners, rivets, clamps, clips, welds, adhesive or any combination of these structures. The base layer 130 can be formed from any appropriate material such as, but not limited to, metal, plastic, natural material, or woven nylon, that has a desired level of flexibility strength and durability. The base layer 130 can abut and be connected to a side of the first arm bracket 88 by any appropriate structure(s) such as but not limited to threaded fasteners, rivets, clamps, clips, welds, adhesive or any combination of these structures.

The cushion layer 132 can abut the outer surface of a respective one of the vertical tanks 31, 32, 33. The cushion layer 132 can be elastically deformable and have relative hardness that is less than the hardness of the vertical tanks 31, 32, 33 and less than the hardness of the base layer 130. The surface of the cushion layer 132 that contacts the respective one of the vertical tanks 31, 32, 33 can have a coefficient of friction that provides a desired frictional force between the cushion layer 132 and the respective one of the vertical tanks 31, 32, 33. The coefficient of friction of the cushion layer 132 can be the same as or similar to the coefficient of friction of the cushion layer 84 of the flexible strap 76. The cushion layer 132 can be fabricated from any appropriate material such as, but not limited to, a natural rubber, a synthetic rubber, or any other known or future developed elastomeric material. The cushion layer 132 can abut and be connected to the base layer 130 by any appropriate manner such as, but not limited to, threaded fasteners, stitches, rivets, clamps, clips, welds, adhesive or any combination of these structures.

Referring to FIG. 8, the second spring assembly 80 can aid in stress relief for the respective flexible strap 76 by absorbing a portion of the tensile stress in the flexible strap 76. The second spring assembly 80 can include a second strap bracket 140, a second arm bracket 142, a second bolt 144, a pair of bolt washers 146, a pair of nuts 148, a pair of spring washers 150 and a second spring 152. The tension load in the flexible strap 76 can be transferred from the second strap bracket 140 into the second bolt 144, and the second bolt 144 can transfer the tension load into the second spring 152. At least a portion of the tension load transferred from the flexible strap 76 into the second spring 152 can be absorbed by compressing the second spring 152, thereby relieving a portion of the tensile stress in the flexible strap 76.

The first spring 94 can have a first spring rate and the second spring 152 can have a second spring rate that is greater than the first spring rate. The relative magnitudes of the first spring rate and the second spring rate can be set to any appropriate value that provides the desired stress relief performance for the flexible strap 76. In exemplary embodiments, the second spring rate can be set at a value at which a dimension tolerance of at least one of the support stand 40 and the hydrogen storage tanks 31, 32, 33 varies from a second predetermined threshold and/or a radial expansion of the respective one of the vertical tanks 31, 32, 33 exceeds a third predetermined threshold.

The second strap bracket 140 can be connected to the flexible strap 76 and the second arm bracket 142 can be connected to the respective one of the brackets 51, 52, 53 to which the first arm bracket 88 is connected. A portion of the second strap bracket 140 can be curved to conform to the circumference of the respective one of the vertical tanks 31, 32, 33. The curved portion of the second strap bracket 140 can abut and be connected to the base layer 82 of the flexible strap 76 by any appropriate structure(s) such as but not limited to threaded fasteners, stitches, rivets, clamps, clips, welds, adhesive or any combination of these structures.

The second arm bracket 142 can be mounted directly onto the respective one of the brackets 51, 52, 53. The second arm bracket 142 can be connected to the respective one of the brackets 51, 52, 53 by any appropriate structure(s) such as but not limited to threaded fasteners, rivets, clamps, clips, welds, adhesive or any combination of these structures. That is, the second arm bracket 142 can be immovably fixed to the support stand 40.

The second bolt 144 can connect the second strap bracket 140 to the second arm bracket 142 and the second spring 152 can be connected to and between each of the second arm bracket 142 and the second bolt 144. That is, the second spring 152 can be connected between the second bolt 144 and the support stand 40.

Each of the brackets 140, 142 can include a through hole and the second bolt 144 can extend through both of the through holes. The through holes are obstructed from view in FIG. 8.

The second spring 152 can be connected between the head of the second bolt 144 and the second arm bracket 142. The second bolt 154 can transfer the tensile force present in the flexible strap 76 to the second spring 152. This load transfer can compress the second spring 152 and the compression of the second spring 152 can relieve at least a portion of the tensile stress in the flexible strap 76.

The second bolt 144 can be tightened or loosened to increase or decrease, respectively, the preload in the second spring 152. Thus, the second bolt 144 can adjust the amount of tensile stress that the second spring 152 can absorb from the flexible strap 76. The second bolt 144 can be referred to as a tension bolt or an adjustable tension bolt and the second spring 152 can be referred to as a stress relief spring. Thus, the second spring assembly 80 can be adjusted to account for manufacturing tolerance(s) in the tank support assembly 38 and diametrical tolerance of the respective one of the vertical tanks 31, 32, 33.

The second spring 152 can be a single component spring or a plurality of spring components. In exemplary embodiments, the second spring 152 can be a stack of conical disc springs. The number of disc springs can be any appropriate number that can provide the desired range of stress relief for the flexible strap 76. The disc springs can also be referred to as Belleville springs, Belleville washers or spring washers. The disc springs can be stacked in the same direction (also referred to as a parallel stack) or alternating directions (also referred to as a series stack) or in alternating sub-stacks of a parallel stack(s) and a series stack(s) in order to achieve the desired spring constant and deflection capacity. The disc springs can be sandwiched between the pair of spring washers 150.

Referring to FIGS. 2-6, each of the vertical tanks 31, 32, 33 can be restrained between the base 42 and the bearing plate 44 in the axial direction A. The base 42 can be rigidly connected to the shaft 54 and each of the plurality of plates 56, 57, 58, 59 of the support stand 40. The bearing plate 44 can be movably supported on the shaft 54 to allow for axial expansion and contraction of the vertical tanks 31, 32, 33.

Referring to FIGS. 3-6, the base 42 that can include a plurality of lobes 154, 156,158 that are connected to each other. The first vertical tank 31 can be located on the first lobe 154, the second vertical tank 32 can be located on the second lobe 156, and the third vertical tank 33 can be located on the third lobe 158. The first plate 56 can be located along a junction of the first lobe 154 and the second lobe 156, the second plate 57 can be located along a junction of the first lobe 154 and the third lobe 158, the third plate 58 can be located along the second lobe 156, and the fourth plate 59 can be located on the third lobe 158. The base 42 can be connected to the shaft 54 and the plurality of plates 56, 57, 58, 59 of the support stand 40 by any appropriate manner such as, but not limited to threaded fasteners, rivets, clamps, clips, welds, adhesive or any combination of these structures.

Referring to FIGS. 3-5 and 8, a pair of threaded fasteners 160 can connect each of the lobes 154, 156, 158 to the main housing 12. The second one of the pair of fasteners 160 for the second lobe 156 and the third lobe 158 is obstructed from view in FIGS. 3-5 and all of the fasteners 160 are omitted from FIG. 6 for clarity and simplicity of the drawing.

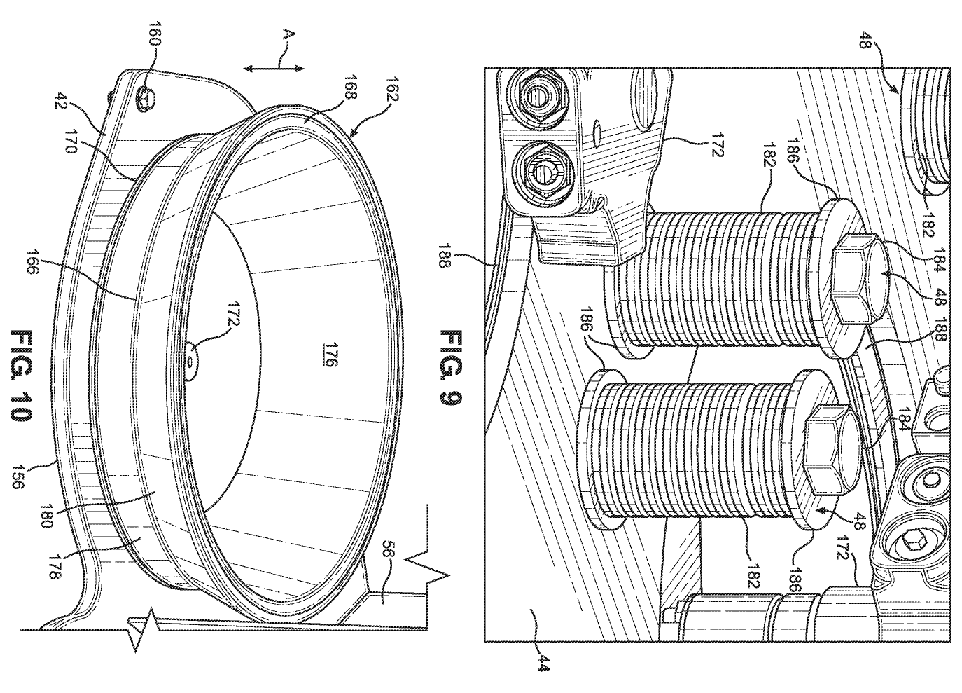

Referring to FIGS. 5 and 10, each of the lobes 154, 156, 158 can include an opening 170 that extends through the respective one of the lobes 154, 156, 158. The opening 170 can be centered on the respective one of the lobes 154, 156, 158. The opening 170 can be a circular opening through which component(s) 172 of the centralized hydrogen distribution system 36 can extend and connect to the respective one of the vertical tanks 31, 32, 33. The diameter of the opening 170 can have any appropriate value. In exemplary embodiments, the opening 170 can have a diameter that is smaller than the outer diameter taken along the longitudinal axis of each of the vertical tanks 31, 32, 33.

Referring to FIGS. 3-6, the bearing plate 44 can have a generally triangular shape with rounded corners. The bearing plate 44 can include a plurality of openings 174, and each of the openings can be adjacent a respective one of the corners. The opening 174 can be a circular opening through which component(s) 172 of the centralized hydrogen distribution system 36 can extend and connect to the respective one of the vertical tanks 31, 32, 33. The opening 174 can be concentric with the center of curvature of the respective rounded corner. The diameter of the opening 174 can have any appropriate value. In exemplary embodiments, the opening 174 can have a diameter that is smaller than the diameter of each of the vertical tanks 31, 32, 33.

Referring to FIGS. 3-6, the tank support assembly 38 can include a plurality of lower end caps 162 and a plurality of upper end caps 164. The lower end caps 162 can be mounted on the base 42 and the upper end caps 164 can be mounted to the bearing plate 44. Each of the lower end caps 162 can be mounted in a respective one of the openings 170 in the base and each of the upper end caps 164 can be mounted in a respective one of the openings 174 in the bearing plate 44.

The upper end caps 164 can be the same as or similar to the lower end caps 162. Details of the lower end caps 162 and the upper end caps 164 are described with respect to the lower end cap 162 of FIG. 10. The end cap 162 can include a structural cap 166 and a cushion liner 168 that abuts an inner side of the structural cap 166 and a respective one of the vertical tanks 31, 32, 33. The structural cap 166 can provide strength and rigidity to the end cap 162 and the cushion liner 168 can resiliently support a respective one of the vertical tanks 31, 32, 33.

The cushion liner 168 can include a bearing surface 176 that has a shape that conforms with the exterior surface at the end of a respective one of the vertical tanks 31, 32, 33. The bearing surface 176 can have a concave, curved shape. The bearing surface 174 can have a relatively low coefficient of friction such that the respective one of the vertical tanks 31, 32, 33 can easily move along the bearing surface as the respective one of the vertical tanks 31, 32, 33 expands and contracts radially and/or longitudinally. The bearing surface 176 can be a coating of relative low friction material such as, but not limited to, nylon, Teflon®, or any other known or future developed plastic or non-plastic material suitable for a bearing surface. The coefficient of friction of the bearing surface 176 can be less than the coefficient of friction of the cushion layer 84 and/or the cushion layer 132 and/or the vertical tanks 31, 32, 33 themselves.

The structural cap 166 can be hollow and opened at the top end and the bottom end in the axial direction A. The structural cap 166 can include a first portion 178 and a second portion 180. The first portion 178 can extend into the opening 170 of the base 42 or the opening 174 of the bearing plate 44. The second portion 180 can protrude away from the respective one of the base 42 and the bearing cap 44 and toward a different one of the base 42 and the bearing cap 44 along the axial direction. The shape of the bearing surface 174 can be complimentary to the inner surfaces of the first portion 178 and the second portion 180.

The cushion lining 168 can cover the inner surface of the first portion 178 and the second portion 180 of the structural cap. The cushion lining 168 can have a softer durometer value as compared to the structural cap 166 and/or the vertical tanks 31, 32, 33 themselves . The cushion lining 168 can be configured to elastically deform to absorb a portion of the expansion of the respective one of the vertical tanks 31, 32, 33. The elastic deformation can also dampen vibrations generated by the vehicle 1 and transmitted to the respective one of the vertical tanks 31, 32, 33 via the cushion lining 168. Thus, the cushion lining 168 can provide protection to the ends of the respective ones of the vertical tanks 31, 32, 33.

The structural cap 166 can be fabricated from any appropriate material such as, but not limited to, aluminum, aluminum alloy, steel, titanium, titanium alloy, carbon fiber, fiber-reinforced plastic, plastic, ceramic or a composite of any of these materials. The cushion liner 168 can be fabricated from any appropriate material such as, but not limited to, a relatively low durometer urethane, any other synthetic rubber material, a natural rubber material, or any other known or future developed elastomeric material.

The structural cap 166 can have any appropriate shape that conforms to the outer surface of the end of the vertical tanks 31, 32, 33. In exemplary embodiments, first portion 178 of the structural cap 166 can be cylindrical and the second portion 180 of the structural cap 166 can be a conical or sphero-conical.

Returning to FIGS. 3-6, each of the vertical tanks 31, 32, 33 can be sandwiched between a respective one of the lower end caps 162 and a respective one of the upper end caps 164. The support stand assembly 38 can be configured to allow each of the vertical tanks 31, 32, 33 to freely and independently expand and contract along the longitudinal axis LA. Specifically, the bearing plate 44 can be movably supported on the shaft 54 and the support stand 38 and the plate spring assembly 48 can be configured to bias the bearing plate 44 into contact with each of the vertical tanks 31, 32, 33.

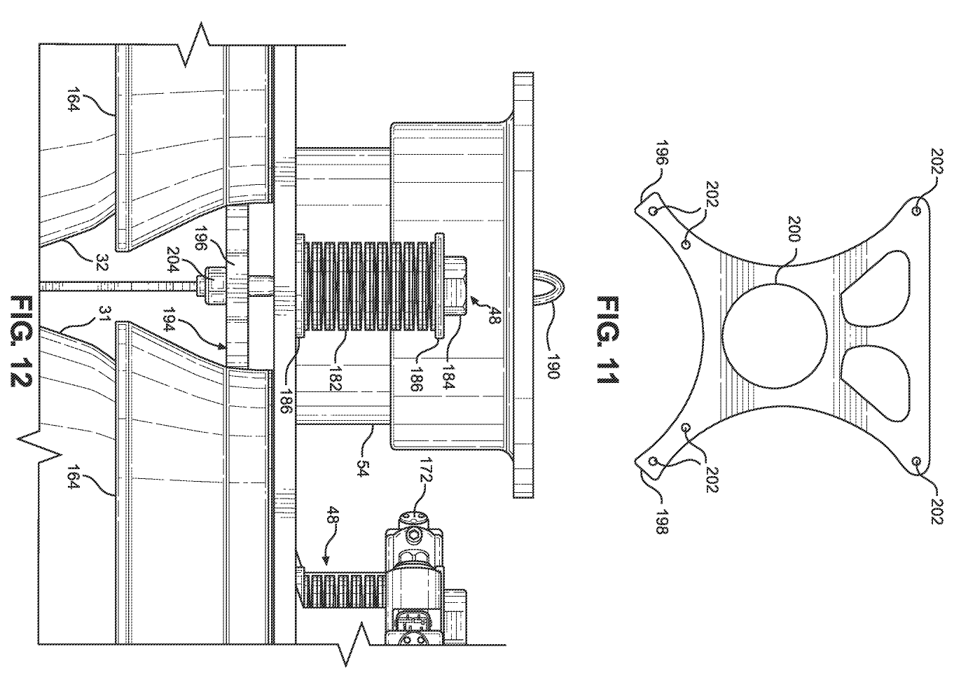

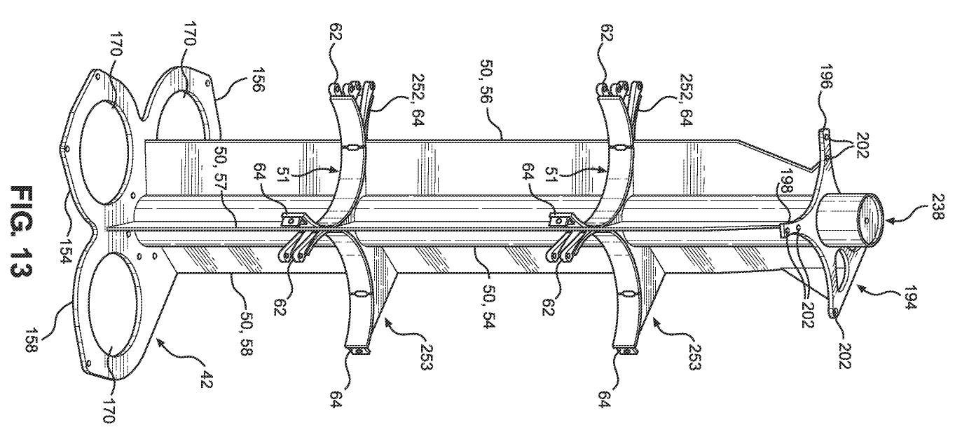

Referring to FIGS. 3-6, the tank support assembly 38 can include a structure such as an anchor plate 194 (FIGS. 11 and 12) that is immovably fixed to the shaft 54 and/or one or more of the plates 56, 57, 58, 59. The anchor plate 194 can be gussetted and welded to shaft 54. The tank support assembly 38 can include a plurality of plate spring assemblies 48 connected to the bearing plate 44 and the anchor plate 194 such that the plate spring assemblies 48 bias the bearing plate 44 toward the vertical tanks 31, 32, 33 along the axial direction A and allow that bearing plate 44 to move along the axial direction as each of the vertical tanks 31, 32, 33 expands and contracts along its longitudinal axis.

Referring to FIG. 11, the anchor plate 194 can include a pair of arms 196, 198, an opening 200 and a plurality of bolt holes 202. The shaft 54 can extend through the opening 200. The anchor plate 194 can be immovably connected to the shaft 54 by any appropriate manner such as, but not limited to threaded fastener(s), rivet(s), clip(s), clamp(s), welding, adhesive, or any combination of these structures. The first arm 196 can be located between the first vertical tank 31 and the second vertical tank 32 and the second arm 198 can be located between the first vertical tank 31 and the third vertical tank 33. Each of the arms 196, 198 can include a respective pair of the bolt holes 202. One of the bolt hole 202 can be located adjacent to a first corner of the anchor plate 194 and the another one of the bolt holes 202 can be located at another corner of the anchor plate 194.

FIG. 12 is a partial side view in the direction of arrow A11 of FIG. 4 and shows the plate spring assembly 48 mounted onto the first arm 196. The second plate spring assembly 48 is obstructed from view in Fig, 12 by the first plate spring assembly 48. The tank support assembly 38 can include a plurality of nuts 204, one for each plate spring assembly 48. The nuts 204 can be threaded onto the respective one of the third bolts 184. In alternate embodiments, the nuts 204 can be welded onto the bottom surface of the support plate 194 and each of the third bolts 184 can be threaded into a respective one of the nuts 204. Thus, the third bolts 184 can be anchored onto the anchor plate 194.

A first pair of the plate spring assemblies 48 can be located between the first vertical tank 31 and the second vertical tank 32. The first pair of tank spring assemblies 48 can be adjacent to each other. A second pair of the plate spring assemblies 48 can be located between the first vertical tank 31 and the third vertical tank 33. The second pair of plate spring assemblies 48 can be adjacent to each other. A third pair of the plate spring assemblies 48 can be located between the second vertical tank 32 and third vertical tank 33. The third pair of plate spring assemblies 48 can be spaced away from each other.

Each of the plate spring assemblies 48 can include a third spring 182, a third bolt 184, a pair of spring washers 186 and a nut 204 (FIG. 12). The nuts 204 are obstructed from view in FIGS. 3-6 and 9 by the bearing plate 44. The third spring 182 can be sandwiched between the spring washers 186 and the spring washers 186 can be sandwiched between the bearing plate 44 and the head of the third bolt 184. The nuts 204 can be tightened against the anchor plate 194 to secure the third bolts 184 to the anchor plate 194. Alternatively, each of the third bolts 184 can be tightened against the washer 186 in embodiments where the nuts 204 are welded onto the anchor plate 194.

Each of the third bolts 184 can be a shoulder bolt that allows the bearing plate 44 to slide axially along the length of the bolts 184. The bolts 184 can have a length that is sufficient to provide adjustment that accounts for axial length tolerance and preload adjustment. The nuts 204 can be locking nuts so that the desired adjustment is maintainable during operation of the vehicle 1.

Referring to FIGS. 3, 4 and 6, the bearing plate 44 can include a central hole 192. The shaft 54 can extend through the central hole 192 and the bearing pate 44 can move along the shaft 54 as any of the vertical tanks 31, 32, 33 expand or contract in the axial direction A.

The bearing plate 44 can include a plurality of bolt holes through, and each of the third bolts 184 can extend through a respective one of the bolt holes. The bolts holes are obstructed from view by the plate spring assemblies 48 in FIGS. 3-6 and 9.

The third spring 182 can be a single component spring or a plurality of spring components. In exemplary embodiments, the third spring 182 can be a stack of conical disc springs. The number of disc springs can be any appropriate number that can provide the desired biasing force on the bearing plate 44 while allowing each of the vertical tanks 31, 32, 33 to freely expand along the longitudinal axis LA. The disc springs can also be referred to as Belleville springs, Belleville washers or spring washers. The disc springs can be stacked in the same direction (also referred to as a parallel stack) or alternating directions (also referred to as a series stack) or in alternating sub-stacks of a parallel stack(s) and a series stack(s) in order to achieve the desired spring constant and deflection capacity. The disc springs can be sandwiched between the pair of spring washers 186.

Referring to FIGS. 4, 5 and 9, the tank support assembly 38 can include at least one removable shim 188 for each of the vertical tanks 31, 32, 33. Any appropriate number of shims 188 can be added or removed for a respective one of the tanks 31, 32, 33 to accommodate manufacturing tolerance in the end-to-end length of the respective one of the vertical tanks 31, 32, 33.

Referring to FIGS. 2-4, the tank support assembly 38 can include a lifting hook 190 that is connected to the shaft 54 of the support stand 40. The lifting hook 190 can be connected to the shaft by any appropriate manner such as, but not limited to threaded fastener(s), rivet(s), clip(s), clamp(s), welding, adhesive, or any combination of these structures. In alternate embodiments, the lifting hook 190 can be removably connected to shaft 54.

The vertical tanks 31, 32, 33 can be pre-assembled onto the tank support assembly 38 prior to installation in the vehicle 1. The lifting hook 190 can be configured to carry the weight of the pre-assembled tank support assembly 38 and vertical tanks 31, 32, 33 to facilitate installation into the hydrogen compartment 30 of the vehicle 1.

Thus, the tank support assembly 38 can orient and retain the plurality of vertical tanks 31, 3233 within the hydrogen compartment 30 with a minimum footprint and also permit each of the vertical tanks 31, 3233 to independently expand and contract in the radial direction R and along the longitudinal axis LA. Further, each of the strap assemblies 45, 46, 47 can be adjustable to vary the tension in the respective flexible strap 76 and provide stress relief for the flexible strap 76. Thus, each of the strap assemblies 45, 46, 47 can accommodate a predetermined range of radial and axial expansion and contraction of the vertical tanks 31, 3233.

FIG. 13 shows an alternate embodiment of the tank support assembly 38 of FIGS. 2-6. Instead of the four plates 56, 57, 58, 59, the tank support assembly 238 of FIG. 13 can omit the fourth plate 59 and the third plate 58 can be repositioned to split the distance between the second vertical tank 32 and the third vertical tank 33. Due to the repositioning of the third plate 58, the tank support assembly 238 can include a second bracket 252 and a third bracket 253 instead of the brackets 52, 53 shown in FIGS. 3-8. The second bracket 252 is obstructed from view in FIG. 13 and can be a mirror image of the third bracket 253. The second and third brackets 252, 253 can have a different shape as compared to the first bracket 51. The second and third brackets 252, 253 can include the same or similar structures as described above with respect to the second and third brackets 52, 53 of FIGS. 3-8.

While certain embodiments of the invention are described above, it should be understood that the invention can be embodied and configured in many different ways without departing from the spirit and scope of the invention.

The electric vehicle 1 is described in the context of a commercial transport vehicle. However, the disclosed main power system 10 can be used with any electric vehicle that is configured for travel along any one or combination of improved, unimproved, and unmarked paths. For example, embodiments are intended to include or otherwise cover any type of vehicle, including a passenger car, a minivan, a sport-utility vehicle, a crossover vehicle, a bus, an off-highway vehicle, a construction vehicle, a locomotive, a boat, a plane, a truck without a trailer, etc.

The HSS 24 can include a pair of tank support assemblies 38. However, alternate embodiments can include a single tank support assembly 38 or more than two tank support assemblies 38.

The HSS 24 described above can include a pair of strap assemblies 45, 46, 47 for each vertical tank 31, 32, 33. However, alternate embodiments can include a single strap assembly 45, 46, 47 or more than two strap assemblies 45, 46, 47 for each vertical tank 31, 32, 33. The number of brackets 51, 52, 53 can be increased or decreased in accordance with the desired number of strap assemblies 45, 46, 47.

In alternate embodiments, the connections between the spring assemblies 78, 80 and the arms 62, 64 can be varied in any manner from those described above so long as one of the spring assemblies 78, 80 is connected to one of the arms 62, 64 and the other of the spring assemblies 78, 80 is connected to the other of the arms 62, 64 of the same bracket 51, 52 or 53.

The spring mount 96 can be omitted from alternate embodiments in which large circumferential displacement of the flexible strap 78 is unnecessary. Instead, the first nut 120 can be welded onto the first strap bracket 86 and the first bolt 90 can be threaded into the welded first nut 120.

Alternate embodiments can replace the pair of arm portions 66, 68, 70, 72 with a single piece for each of the arms 62, 64 and omit the extension 126 and the second pivot pin 128 and C-clip 138. In these alternate embodiments, the first arm bracket 88 can be directly mounted onto the respective one of the arms 62, 64 by any appropriate manner such as, but not limited to, welding, threaded fasteners, rivets, adhesives, clamps, clips, or any combination of these structures.

The tank support assembly 38 described with respect to FIGS. 3-6 and 9 shows six tank spring assemblies 48. However, the number of tank spring assemblies 48 can be more or less than that shown in FIGS. 3-6 and 9 and described above.

In alternate embodiments, the first spring 94 can include more than one coil spring. Instead of a coil spring, the first spring 94 can be any appropriate spring structure such as, but not limited to an elastomer block with a central hole for the first bolt 90 in alternate embodiments. In alternate embodiments, the first spring 94 can be a spring stack such as described above with respect to the second spring 152 or the third spring 182.

Instead of two C-clips 112, the spring mount 96 can include a first pivot pin 108 that includes a head such as, but not limited to, the head 136 of the second pivot pin 128. In this alternate embodiment, the head can replace one of the grooves and a respective one of the single C-clips 112.

The fuel cell system 22 can include any currently known or future-developed fuel cell structure(s). Alternate embodiments of the fuel cell can include any appropriate chemical reaction(s) that produces electrons that can be stored in a battery, capacitor or any other known of future developed electron storage device. Thus, the tank support assemblies can be configured to carry materials other than hydrogen, depending on application.

Instead of two electric motors, alternate embodiments of the electric vehicle can include one electric motor or more than two electric motors. The electric motor(s) can be directly coupled to a respective wheel or pair of wheels. In alternate, embodiments, a geartrain can transfer the output by the electric motor(s) to the respective wheel(s).

Instead of the three vertical tanks 31, 32, 33 shown FIGS. 2 and 3, the tanks support assembly 38 can include any appropriate number of vertical tanks. In alternate embodiments, the number of vertical tanks supported by the left tank support assembly 38 can be different from the number of tanks supported by the right tank support assembly 38.

In alternate embodiments, the vertical tanks 31, 32, 33 can be different from each other in any one or combination of shape, length, diameter, storage capacity, etc.

Instead of two tank support assemblies 38, the HSS 24 can include a single tank support assembly 38 that is configured to support any desired number of the vertical tank(s).

Instead of two strap assemblies for each vertical tank(s), alternate embodiments can include more than two strap assemblies or a single strap assembly for each vertical tank(s).

Instead of two tank spring assemblies 48 for each vertical tank(s), alternate embodiments of the HSS 24 can include more than two tank spring assemblies 48 for each vertical tank(s).

Alternate embodiments of the HSS 24 can include end caps 162, 164 that are different in shape as compared to that shown in FIGS. 2-6 and 10.

What is claimed is:

1. A tank support assembly for a hydrogen storage system of a fuel cell electric vehicle, comprising:
a support stand configured to receive and support at least one hydrogen gas storage tank;
a base connected to the support stand and configured to receive and support the hydrogen gas storage tank;
a bearing plate movably connected to the support stand at a location that is spaced away from the base, the bearing plate opposes the base and is configured to be connected to the hydrogen gas storage tank;
a strap assembly connected to the support stand at a location that is between the base and the bearing plate and configured to constrain the hydrogen gas storage tank onto the support stand, the strap assembly includes:
a flexible strap;
a tension spring connected between the support stand and the flexible strap, the tension spring is configured to apply a radial direction holding force to compensate for radial expansion of the hydrogen gas storage tank, the tension spring has a spring constant; and
a stress relief spring connected between the support stand and the flexible strap, the stress relief spring has a spring constant that is greater than the spring constant of the tension spring; and
a plate spring connected to the bearing plate and configured to maintain contact between the bearing plate and the hydrogen gas storage tank as the hydrogen gas tank expands and contracts along a longitudinal axis of the hydrogen gas storage tank.

2. The tank support assembly according to claim 1, further comprising:
a first end cap mounted onto one of the base and the bearing plate, the first end cap includes a bearing surface that is configured to abut one end of the hydrogen gas storage tank, the bearing surface is configured to permit movement of the one end of the hydrogen gas storage tank along the bearing surface as the hydrogen gas storage tank expands and contracts along at least one of the longitudinal axis and a radial direction of the hydrogen gas storage tank.

3. The tank support assembly according to claim 2, further comprising:
a second end cap mounted onto a different one of the base and the bearing plate, the second end cap includes a bearing surface that is configured to abut another end of the hydrogen gas storage tank, the bearing surface of the second end cap is configured to permit movement of the another end of the hydrogen gas storage tank along the bearing surface of the second end cap as the hydrogen gas storage tank expands and contracts along at least one of the longitudinal axis and the radial direction, wherein
each of the first end cap and the second end cap is made from aluminum and includes a urethane liner that is configured to abut the hydrogen gas storage tank, and
the bearing surface of each of the first end cap and the second end cap is a plastic surface.

4. The tank support assembly according to claim 1, wherein
the flexible strap includes a first end and a second end;
the strap assembly further includes:
a first strap mounting bracket connected to the first end of the flexible strap;
a first tension bolt including a first end connected to the first strap mounting bracket;
a second strap mounting bracket connected to the second end of the flexible strap; and
a second tension bolt including a first end connected to the second strap mounting bracket, wherein
the tension spring is connected between the first tension bolt and the support stand,
the stress relief spring is connected between the second tension bolt and the support stand, and
the second tension bolt is configured to vary stress relief in the flexible strap that is provided by the stress relief spring.

5. The tank support assembly according to claim 4, wherein
the first tension bolt is pivotally connected to the first strap mounting bracket and is configured to pivot if the hydrogen gas storage tank expands in a radial direction beyond a first predetermined threshold, and
the second tension bolt is configured to vary the tension relief in the flexible strap if a dimension tolerance of at least one of the support stand and the hydrogen storage tanks varies from a second predetermined threshold.

6. The tank support assembly according to claim 1, wherein:
the support stand and the base are configured to receive a plurality of hydrogen gas storage tanks and arrange the hydrogen storage tanks into a triangular array.

7. The tank support assembly according to claim 1, wherein
the flexible strap includes a friction surface that that is configured to abut the hydrogen gas storage tank, the friction surface has a first coefficient of friction, and
the base includes a support surface that abuts the first hydrogen gas storage tank, the support surface has a second coefficient of friction that is less than the first coefficient of friction.

8. The tank support assembly according to claim 1, wherein
the flexible strap is configured to expand and contract as the hydrogen gas storage tank expands and contracts in a radial direction of the hydrogen gas storage tank,
the plate spring is configured to contract and expand as the hydrogen gas storage tank expands and contracts along a longitudinal axis of the hydrogen gas storage tank, and
the stress relief spring expands to relieve stress in the flexible strap as the first hydrogen gas storage tank expands in the radial direction.

9. A tank support assembly for a hydrogen storage system of a fuel cell electric vehicle, comprising:
a support stand configured to receive and support at least one hydrogen gas storage tank;
a base connected to the support stand and configured to receive and support the hydrogen gas storage tank;
a bearing plate connected to the support stand and opposing the base, the bearing plate is configured to be connected to the hydrogen gas storage tank;
a flexible strap having a first end and a second end, the flexible strap is configured to constrain the hydrogen gas storage tanks against the support stand;
a first spring assembly connected between the support stand and the first end of the flexible strap, the first spring assembly is configured to bias the flexible strap against the hydrogen gas storage tank, the first spring assembly has a spring constant; and
a second spring assembly connected to the bearing plate and configured to bias the bearing plate against the hydrogen gas storage tank and permit displacement of the bearing plate as the hydrogen gas storage tank undergoes axial expansion and contraction.

10. The tank support assembly according to claim 9, wherein
the support stand includes a main body and a bracket connected to and extending away from the main body, the bracket is configured to receive and support the hydrogen gas storage tank and includes a pair of arms that oppose each other,
the first spring assembly is connected to a first one of the arms and the second spring assembly is connected to a second one of the arms.

11. The tank support assembly according to claim 10, wherein
each of the arms terminates at a free end,
the support stand includes a cushion lining that extends along the bracket from the free end of the first one of the arms to the free end of the second one of the arms, and
the flexible strap includes a cushion layer that extends from the first end of the flexible strap to the second end of the flexible strap, the cushion layer faces toward the main body and is configured to abut the hydrogen gas storage tank.

12. The tank support assembly according to claim 10, wherein the first spring assembly includes:
a first strap bracket mounted on the flexible strap;
a first arm bracket connected to the first one of the arms;
a first bolt pivotally connected to the first strap bracket and passing through the first arm bracket; and
a tension spring connected between the first bolt and the first arm bracket.

13. The tank support assembly according to claim 10, further comprising:
a third spring assembly connected between the support stand and the second end of the flexible strap, the third spring assembly has a spring constant that is greater than the spring constant of the first spring assembly.

14. The tank support assembly according to claim 13, wherein the third spring assembly includes:
a second strap bracket mounted on the flexible strap;
a second arm bracket mounted on the second one of the arms;
a second bolt connected to the second strap bracket and passing through the second arm bracket; and
a stress relief spring connected between the second bolt and the second arm bracket.

15. The tank support assembly according to claim 9, wherein the second spring assembly includes:
a second spring biasing the bearing plate toward the base; and
a bolt passing through the second spring, the bolt is fixed relative to the support stand.

16. The tank support assembly according to claim 15, wherein the third spring includes a plurality of disc springs that are stacked on each other.

17. A tank support assembly for a hydrogen storage system of a fuel cell electric vehicle, comprising:
a support stand configured to receive and support a plurality of hydrogen gas storage tanks;
a base connected to the support stand and configured to receive and support the hydrogen gas storage tanks;
a bearing plate connected to the support stand and opposing the base, the bearing plate is configured to be connected to the hydrogen gas storage tanks;
a flexible strap having a first end and a second end, the first strap is configured to constrain one of the hydrogen gas storage tanks against the support stand;
a first spring assembly connected between the support stand and the first end of the flexible strap, the first spring assembly is configured to bias the flexible strap against the one of the hydrogen gas storage tanks, the first spring has a spring constant;
a second spring assembly connected between the support stand and the second end of the flexible strap, the second spring assembly has a spring constant that is greater than the spring constant of the first spring assembly; and
a third spring assembly connected to the bearing plate and configured to bias the bearing plate against the one of the hydrogen gas storage tanks and permit displacement of the bearing plate as the one of the hydrogen gas tank undergoes axial expansion and contraction.

18. The tank support assembly according to claim 17, further comprising:
a first end cap connected to the base, the first end cap includes:
a first support member mounted on the base;
a first cushion layer disposed on the first support member;
a first bearing surface formed on the first cushion layer such that the first cushion layer is located between the first bearing surface and the first support member, the first bearing surface is a concave curved surface and configured to abut one end of the one of the hydrogen gas storage tanks; and
a second end cap connected to the bearing plate, the second end cap includes,
a second support member mounted on the bearing plate;
a second cushion layer disposed on the second support member;
a second bearing surface formed on the second cushion layer such that the second cushion layer is located between the second bearing surface and the second support member, the second bearing surface is a concave curved surface and configured to abut another end of the one of the hydrogen gas storage tanks.

19. The tank support assembly according to claim 17, further comprising:
a lifting hook connected to the support stand and extending away from the bearing plate.

20. An electric vehicle comprising:
the tank support assembly according to claim 17;
a chassis extending in a longitudinal direction and a transverse direction;
a cab mounted on the chassis and extending away from the chassis in a vertical direction; and
a plurality of hydrogen gas storage tanks mounted onto the tank support assembly, wherein
the support stand is elongated in the vertical direction,
the base is connected to the chassis and located between the chassis and the bearing plate in the vertical direction, and
each of the hydrogen gas storage tanks is cylindrical and has a longitudinal axis that extends along the vertical direction.
